(19) United States
(12) Patent Application Publication
(10) Pub. No.: US 2024/0229834 A9
(43) Pub. Date: Jul. 11, 2024

(54) FLAT TRANSMISSION DEVICE AND CLAMP DEVICE

(71) Applicant: TSUBAKIMOTO CHAIN CO., Osaka (JP)

(72) Inventors: Kazuma Takahashi, Osaka-shi (JP); Keiichi Tsukiyoshi, Osaka-shi (JP)

(73) Assignee: TSUBAKIMOTO CHAIN CO., Osaka (JP)

(21) Appl. No.: 18/278,745

(22) PCT Filed: Feb. 16, 2022
(86) PCT No.: PCT/JP2022/006244

§ 371 Date: Aug. 24, 2023

(30) Foreign Application Priority Data
Mar. 3, 2021 (JP) 2021-033473

(51) Int. Cl. F16B 2/06; F16L 3/01; F16L 3/10; H01B 7/08; H02G 3/32

(52) U.S. Cl. CPC F16B 2/06; F16L 3/01; F16L 3/10; H01B 7/0823; H02G 3/32

(57) ABSTRACT

A flat transmission device includes a belt-shaped unit and a clamp device. The clamp device includes a main clamp member that covers a part of an end of the belt-shaped unit in the width direction including a side edge of the belt-shaped unit on a first side in the width direction, and an auxiliary clamp member that covers a part of the end of the belt-shaped unit in the width direction including a side edge of the belt-shaped unit on a second side in the width direction. The main clamp member and the auxiliary clamp member move relative to each other while partially overlapping with each other in the width direction, thereby cooperatively entirely covering the end of the belt-shaped unit in the width direction.

### TECHNICAL FIELD

The present disclosure relates to a flat transmission device and a clamp device. The transmission device includes elongated flexible transmission members that are used to transmit, for example, electricity, pressure, or the like, and are arranged in parallel to form a band shape. The clamp device fixes ends of the transmission members in a longitudinal direction.

### BACKGROUND ART

For example, Patent Literature 1 discloses a flat transmission device that includes an elongated belt-shaped unit. The belt-shaped unit includes flexible tubular transmission members through which cables can be passed or compressed air or the like can be transmitted. Specifically, the belt-shaped unit is formed by connecting adjacent transmission members in a state in which the transmission members are arranged in parallel. One end in the longitudinal direction of the belt-shaped unit is fixed to an installation surface or the like of equipment by a clamp device. The other end in the longitudinal direction of the belt-shaped unit is fixed to a movable unit or the like included in the equipment by a clamp device.

### CITATION LIST

### Patent Literature

Patent Literature 1: Japanese Laid-Open Patent Publication No. 2015-109750

### SUMMARY OF INVENTION

### Technical Problem

In a flat transmission device, when the number of required cables or the like is changed due to a difference in specifications for the equipment in which the device is installed, the width of the belt-shaped unit is also changed. The clamp device fixes an end of the belt-shaped unit in a state of entirely covering the end in the width direction. Thus, when the width of the belt-shaped unit is changed as described above, it is necessary to redesign the clamp device in accordance with the change in the width. This results in reduced versatility of the clamp device used to fix an end of a belt-shaped unit.

### Solution to Problem

To achieve the foregoing objectives, a flat transmission device includes a belt-shaped unit that includes elongated flexible transmission members arranged in parallel and a clamp device configured to fix an end in a longitudinal direction of the belt-shaped unit in a state of entirely covering the end in a width direction of the belt-shaped unit. The clamp device includes a main clamp member that covers at least a part of the end of the belt-shaped unit in the width direction including a side edge of the belt-shaped unit on a first side in the width direction, and an auxiliary clamp member that covers at least a part of the end of the belt-shaped unit in the width direction including a side edge of the belt-shaped unit on a second side in the width direction. The main clamp member and the auxiliary clamp member move relative to each other while partially overlapping with each other in the width direction, thereby cooperatively entirely covering the end of the belt-shaped unit in the width direction.

To achieve the foregoing objectives, a clamp device is provided in a flat transmission device. The flat transmission device includes a belt-shaped unit that includes elongated flexible transmission members arranged in parallel. The clamp device is configured to fix an end in a longitudinal direction of the belt-shaped unit in a state of entirely covering the end in a width direction of the belt-shaped unit. The clamp device includes a main clamp member that covers at least a part of the end of the belt-shaped unit in the width direction including a side edge of the belt-shaped unit on a first side in the width direction, and an auxiliary clamp member that covers at least a part of the end of the belt-shaped unit in the width direction including a side edge of the belt-shaped unit on a second side in the width direction. The main clamp member and the auxiliary clamp member move relative to each other while partially overlapping with each other in the width direction, thereby cooperatively entirely covering the end of the belt-shaped unit in the width direction.

### BRIEF DESCRIPTION OF DRAWINGS

FIG. 1 is a perspective view schematically showing a flat transmission device according to one embodiment.

FIG. 2 is a side view schematically showing a use state of the flat transmission device.

FIG. 3 is a plan view showing a state in which an end of a belt-shaped unit is fixed by a clamp device.

FIG. 4 is a cross-sectional view taken along line 4-4 in FIG. 3.

FIG. 5 is a plan view showing a state in which an end of a wide belt-shaped unit is fixed by the clamp device.

FIG. 6 is a plan view showing a state in which an end of a narrow belt-shaped unit is fixed by the clamp device.

FIG. 7 is a perspective view showing a state in which an end of a belt-shaped unit is fixed by a clamp device according to a first modification.

FIG. 8 is a perspective view showing a state in which an end of a belt-shaped unit is fixed by a clamp device according to a second modification.

FIG. 9 is a perspective view showing a state in which an end of a belt-shaped unit that is narrower than the belt-shaped unit shown in FIG. 8 is fixed by the clamp device according to the second modification.

### DESCRIPTION OF EMBODIMENTS

A flat transmission device and a clamp device according to one embodiment will now be described with reference to the drawings. The clamp device is used to fix an end of a belt-shaped unit of the flat transmission device.

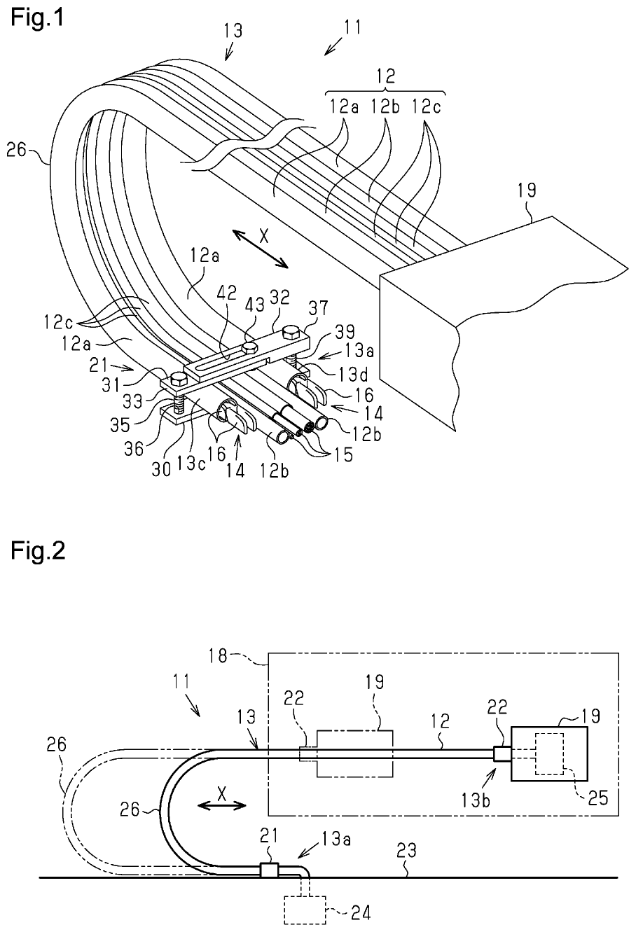

As shown in FIG. 1, a flat transmission device 11 includes a belt-shaped unit 13. The belt-shaped unit 13 includes flexible transmission members 12, which are elongated tubes made of plastic. In the present embodiment, the belt-shaped unit 13 includes seven transmission members 12. Specifically, the seven transmission members 12 are integrated, for example, by welding adjacent transmission members 12 in a state in which the transmission members 12 are arranged in parallel. The seven transmission members 12 include two transmission members 12a. The two transmission members 12a are located at opposite ends of the arrangement direction of the seven transmission members 12. Articulated supporting members 14, which are longer than the transmission members 12a, are respectively inserted into the two transmission members 12a so as to contact the inner peripheral surfaces of the tubular transmission members 12a. That is, the articulated supporting members 14 are inserted into the tubular members that are referred to as transmission members 12a.

The seven transmission members 12 also include two transmission members 12b. These two transmission members 12b are positioned respectively adjacent to the two transmission members 12a on the inner side in the width direction, which is also the arrangement direction. The two transmission members 12b are configured to function as hoses capable of transmitting at least one of pneumatic and hydraulic pressures. That is, the inside of the two transmission members 12b remains hollow, and nothing is inserted therein. The seven transmission members 12 further include three transmission members 12c positioned between the two transmission members 12b, which function as hoses. A flexible cable 15, which is longer than the transmission members 12c, is inserted into each transmission member 12c so as to transmit electricity such as power or signals. The outer diameter of each cable 15 is smaller than the inner diameter of the transmission member 12c for accommodating a cable, so that the cable 15 can be inserted into the transmission member 12c.

Each articulated supporting member 14 is an elongated member that includes link members 16 arranged in series. Adjacent ones of the link members 16 are pivotally coupled to each other. Each articulated supporting member 14 is allowed to bend toward a first side in a direction intersecting with its longitudinal direction, which is a series arrangement direction, within a range up to a set bend radius, while being restricted from bending toward a second side, which is opposite to the first side. In the case of the present embodiment, when the belt-shaped unit 13 is bent in a semi-circular shape as shown in FIG. 1, the articulated supporting members 14 are allowed to bend toward the inner peripheral side, and restricted from bending toward the opposite outer peripheral side.

The cables 15 are routed to supply electric power to a movable unit 19, which is movably provided in equipment 18 such as a machine tool.

As shown in FIG. 2, the flat transmission device 11 is used to protect and guide the cables 15 in accordance with movement of the movable unit 19. The belt-shaped unit 13 includes a first end portion 13a and a second end portion 13b in its longitudinal direction. The first end portion 13a is fixed by means of a first clamp device 21. The second end portion 13b is fixed by means of a second clamp device 22. In this case, the first end portion 13a of the belt-shaped unit 13 is a fixed end that is fixed in an immovable state by the first clamp device 21. In contrast, the second end portion 13b of the belt-shaped unit 13 is fixed to the movable unit 19 by the second clamp device 22 and serves as a movable end that moves along a moving direction X of the movable unit 19.

That is, the first end portion 13a of the belt-shaped unit 13 is fixed by the first clamp device 21 at a specified position of an installation surface 23 along a direction parallel to the moving direction X of the movable unit 19. End portions of the cables 15 protruding from the end portions of the transmission members 12c at the first end portion 13a of the belt-shaped unit 13 are connected to a power supply 24 disposed on the installation surface 23. The second end portion 13b of the belt-shaped unit 13 is fixed to the movable unit 19 in the equipment 18 by the second clamp device 22. Specifically, the second end portion 13b is connected to an electrical device 25, which is arranged inside the movable unit 19. The transmission members 12b, which serve pressure transmitting hoses, each have a first end connected to a pressure source (not shown) and a second end connected to a cylinder mechanism (not shown) or the like in the movable unit 19.

The belt-shaped unit 13 includes a bent portion 26 between the first end portion 13a and the second end portion 13b in the longitudinal direction. The bent portion 26 is located at a position farther from the second end portion 13b than from the first end portion 13a in the moving direction X of the movable unit 19. The bent portion 26 has a semi-circular shape bulging away from the second end portion 13b. A part of the belt-shaped unit 13 between the first end portion 13a and the bent portion 26 in the longitudinal direction extends along the installation surface 23. A part of the belt-shaped unit 13 between the second end portion 13b and the bent portion 26 in the longitudinal direction is arranged at a height at which the movable unit 19 moves and extends parallel with the installation surface 23. The belt-shaped unit 13 is configured such that as the second end portion 13b moves together with the movable unit 19 of the equipment 18, the bent portion 26 is displaced in the moving direction X of the movable unit 19.

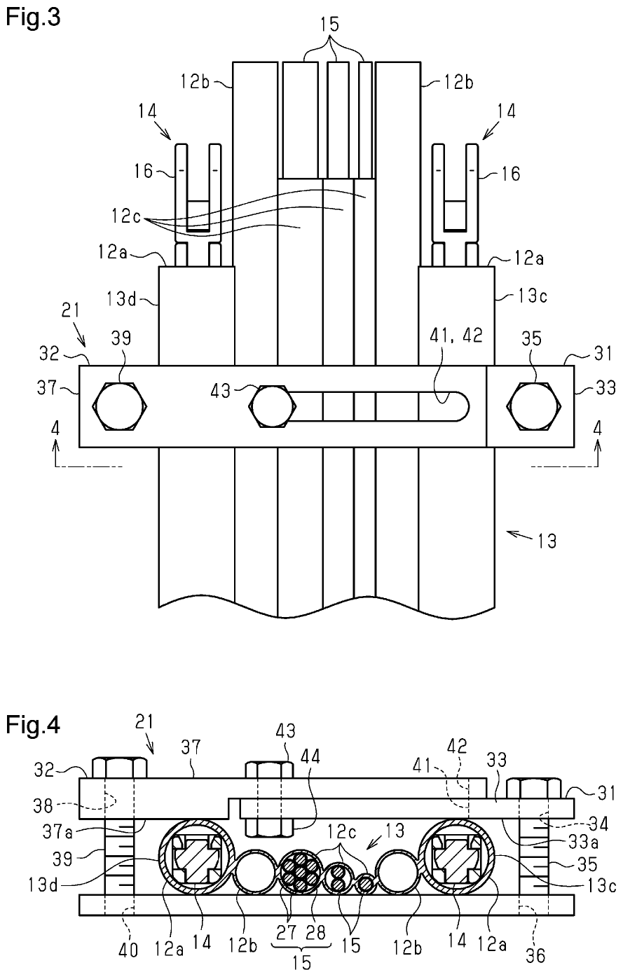

As shown in FIGS. 3 and 4, among the seven transmission members 12a, 12b, and 12c, which form the belt-shaped unit 13, the two transmission members 12a, which are located at the opposite ends in the arrangement direction, are formed to have a larger outer diameter than the other transmission members 12b and 12c. In other words, the belt-shaped unit 13 includes the transmission members 12a, into which the articulated supporting members 14 are inserted, the transmission members 12b, which transmit pneumatic pressure or the like, and the transmission members 12c, into which the cables 15 are inserted. The transmission members 12a are located at the opposite ends in the arrangement direction. The transmission members 12b, 12c are located at positions other than the opposite ends in the arrangement direction and are formed to have smaller outer diameters than those of the transmission members 12a. The transmission members 12c for accommodating cables include three transmission members 12c having relatively large, medium, and small outer diameters. The transmission member 12c having the largest diameter among the three transmission members 12c is formed to have the same outer diameter as that of the transmission members 12b, which transmit pneumatic pressure or the like. The cables 15 inserted into the respective transmission members 12c include one or more electric wires 27 and an elongated and tubular insulating body 28 covering the electric wires 27.

The first clamp device 21 and the second clamp device 22, which are used to fix the end portions of the belt-shaped unit 13, will now be described. Since the first clamp device 21 and the second clamp device 22 have the same configuration, hereinafter, the first clamp device 21 will be described, and redundant description of the second clamp device 22 will be omitted.

As shown in FIGS. 1 and 3, the first clamp device 21 includes a band plate-shaped main clamp member 31 and a band plate-shaped auxiliary clamp member 32, which clamp and fix the first end portion 13a of the belt-shaped unit 13 between the main clamp member 31 and a fixing member 30 provided in the equipment 18. The belt-shaped unit 13 includes a side edge 13c on one side in the width direction, that is, on a first side in the width direction, and a side edge 13d on the other side in the width direction, that is, on a second side in the width direction. The main clamp member 31 is disposed along the width direction of the belt-shaped unit 13 at a position facing the fixing member 30, so that the main clamp member 31 covers a part in the width direction of the first end portion 13a of the belt-shaped unit 13 including the side edge 13c. The auxiliary clamp member 32 is disposed along the width direction of the belt-shaped unit 13 at a position facing the fixing member 30, so that the auxiliary clamp member 32 covers a part in the width direction of the first end portion 13a of the belt-shaped unit 13 including the side edge 13d.

The main clamp member 31 and the auxiliary clamp member 32 are band plate members having the same dimension in the traverse direction. The dimension of the auxiliary clamp member 32 in the longitudinal direction is longer than that of the main clamp member 31. The main clamp member 31 and the auxiliary clamp member 32 move relative to each other in the width direction of the belt-shaped unit 13 while partially overlapping with each other, thereby cooperatively entirely covering the end of the belt-shaped unit 13 in the width direction, as shown in FIGS. 1 and 3.

As shown in FIG. 4, the main clamp member 31 includes a main plate portion 33 and a main bolt 35. The main plate portion 33 has a uniform thickness over the entire length. The main plate portion 33 includes a bolt hole 34 at a proximal end portion in the longitudinal direction. The main bolt 35 is screwed into the bolt hole 34. The fixing member 30 includes a bolt hole 36 in a first end portion. When the main plate portion 33 extends in the width direction of the belt-shaped unit 13 and the main bolt 35 screwed into the bolt hole 34 is screwed into the bolt hole 36 of the fixing member 30, the main clamp member 31 covers the first side in the width direction of the belt-shaped unit 13. At this time, the main bolt 35 is located outward of the side edge 13c on the first side in the width direction of the belt-shaped unit 13, so that the first end portion 13a of the belt-shaped unit 13 held between the main bolt 35 and the fixing member 30 is prevented from being displaced toward the first side in the width direction. In this respect, the main bolt 35 of the main clamp member 31 functions as a first movement restricting portion, which restricts the first end portion 13a of the belt-shaped unit 13 from moving toward the first side in the width direction and being displaced.

On the other hand, the auxiliary clamp member 32 includes an auxiliary plate portion 37 and an auxiliary bolt 39. In the auxiliary plate portion 37, the thicknesses of a section from the midpoint to the distal end in the longitudinal direction is different from the thickness of a section on the proximal end in the longitudinal direction. The auxiliary plate portion 37 includes a bolt hole 38 at a proximal end portion in the longitudinal direction. The auxiliary bolt 39 is screwed into the bolt hole 38. The proximal end portion of the auxiliary plate portion 37 is thicker than the distal side portion of the auxiliary plate portion 37. The distal end portion of the auxiliary plate portion 37 overlaps with the main plate portion 33 when the auxiliary clamp member 32 cooperates with the main clamp member 31 to entirely cover the end of the belt-shaped unit 13 in the width direction. The auxiliary plate portion 37 of the present embodiment is a plate member in which the thickness of a thin portion at the distal end is the same as that of the main plate portion 33, and the thickness of a thick portion at the proximal end is substantially twice that of the main plate portion 33.

The fixing member 30 includes a bolt hole 40 in a second end portion. When the auxiliary plate portion 37 extends in the width direction of the belt-shaped unit 13 and auxiliary bolt 39 screwed into the bolt hole 38 is screwed into the bolt hole 40 of the fixing member 30, the auxiliary clamp member 32 covers the second side in the width direction of the belt-shaped unit 13. At this time, the auxiliary bolt 39 is located outward of the side edge 13d on the second side in the width direction of the belt-shaped unit 13, so that the first end portion 13a of the belt-shaped unit 13 held between the auxiliary bolt 39 and the fixing member 30 is prevented from being displaced toward the second side in the width direction. In this respect, the auxiliary bolt 39 of the auxiliary clamp member 32 functions as a second movement restricting portion, which restricts the first end portion 13a of the belt-shaped unit 13 from moving toward the second side in the width direction and being displaced.

As shown in FIGS. 1, 3 and 4, the main plate portion 33 of the main clamp member 31 includes a first elongated hole 41, which extends in the longitudinal direction of the main plate portion 33. The auxiliary plate portion 37 of the auxiliary clamp member 32 includes a second elongated hole 42 at the thin portion at the distal end. The second elongated hole 42 extends in the longitudinal direction of the auxiliary plate portion 37. The first elongated hole 41 and the second elongated hole 42 have the same shape. The main clamp member 31 and the auxiliary clamp member 32 are moved relative to each other in the width direction of the belt-shaped unit 13 in a state in which the first elongated hole 41 and the second elongated hole 42 at least partly overlap with each other, thereby adjusting the length in the width direction by which the main clamp member 31 and the auxiliary clamp member 32 cooperate to cover the first end portion 13a of the belt-shaped unit 13. The main clamp member 31 and the auxiliary clamp member 32 are positioned and fixed in a state of cooperatively covering the belt-shaped unit 13 having a specified width when a nut 44 is fastened to a fastening bolt 43 inserted into the overlapping portion of the first elongated hole 41 of the main plate portion 33 and the second elongated hole 42 of the auxiliary plate portion 37.

As shown in FIG. 4, the main plate portion 33 of the main clamp member 31 includes a main contact portion 33a, which contacts the belt-shaped unit 13 so as to limit upward displacement of the belt-shaped unit 13. The auxiliary plate portion 37 of the auxiliary clamp member 32 includes an auxiliary contact portion 37a, which contacts the belt-shaped unit 13 so as to limit upward displacement of the belt-shaped unit 13. The main contact portion 33a is formed by a surface of the main plate portion 33 that faces the fixing member 30. The auxiliary contact portion 37a is formed by a surface of the proximal thick portion of the auxiliary plate portion 37 that faces the fixing member 30. Among the transmission members 12 of the belt-shaped unit 13, the main contact portion 33a and the auxiliary contact portion 37a contact the large-diameter transmission members 12a, which are located at the end on the first side and the end on the second side in the width direction and into which the articulated supporting members 14 are inserted. In other words, among the transmission members 12 of the belt-shaped unit 13, the main contact portion 33a and the auxiliary contact portion 37a do not contact the transmission members 12b, 12c, which are located at positions other than the opposite ends in the width direction. Specifically, the main contact portion 33a and the auxiliary contact portion 37a do not contact the transmission members 12b, which transmit pneumatic pressure or the like, and the transmission members 12c, into which the cables 15 are inserted. Since the main contact portion 33a and the auxiliary contact portion 37a contact the large-diameter transmission members 12a, into which the articulated supporting members 14 are inserted, in the above-described manner, the belt-shaped unit 13 is prevented from being displaced upward from the fixing member 30.

Operation of the present embodiment will now be described.

In the flat transmission device 11, the number of the transmission members 12 may be changed in accordance with the specification of the equipment 18 in which the flat transmission device 11 is installed. This changes the width of the belt-shaped unit 13 formed by the transmission members 12. In such a case, for example, in the first clamp device 21, which clamps and fixes the first end portion 13a of the belt-shaped unit 13 between the first clamp device 21 and the fixing member 30, the main clamp member 31 and the auxiliary clamp member 32 move relative to each other as described below, thereby responding to the change in the width of the belt-shaped unit 13. The second clamp device 22, which clamps and fixes the second end portion 13b of the belt-shaped unit 13 between the second clamp device 22 and the fixing member 30 operates in a manner similar to that of the first clamp device 21. Accordingly, operation of the first clamp device 21 will be described below, and a redundant description of operation of the second clamp device 22 will be omitted.

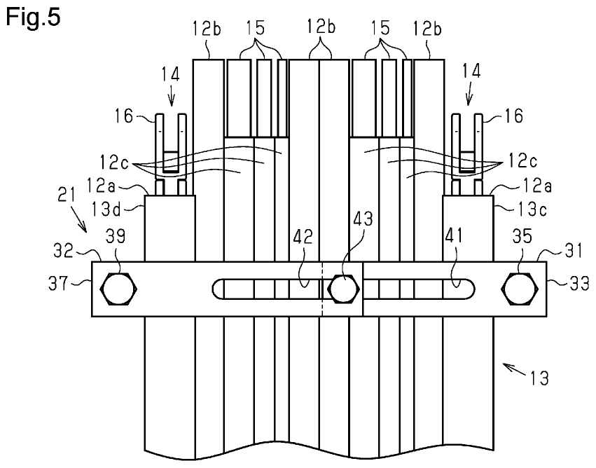

First, as shown in FIG. 5, among the transmission members 12a, 12b, 12c of the belt-shaped unit 13, when the number of the pressure-transmitting hose-shaped transmission members 12b and the transmission members 12c, through which the cables 15 are inserted, is increased, so that the belt-shaped unit 13 is widened, the following measures are taken. In the first clamp device 21, the fastening bolt 43, which is inserted through the overlapping portion of the first elongated hole 41 of the main clamp member 31 and the second elongated hole 42 of the auxiliary clamp member 32, is loosened from the nut 44. Also, the main bolt 35 is unscrewed from the bolt hole 36, and the auxiliary bolt 39 is unscrewed from the bolt hole 40. Accordingly, the main clamp member 31 and the auxiliary clamp member 32 are movable relative to each other within a range in which the fastening bolt 43 slides along the first elongated hole 41 and the second elongated hole 42.

In this case, the main clamp member 31 and the auxiliary clamp member 32 are moved away from each other, for example, in the width direction of the belt-shaped unit 13. When the fastening bolt 43 is engaged with the left end edge of the first elongated hole 41 and the right end edge of the second elongated hole 42 in FIG. 5, the main clamp member 31 and the auxiliary clamp member 32 do not move further away from each other in the width direction of the belt-shaped unit 13. In this state, the fastening bolt 43 is screwed into the nut 44, and the main bolt 35 and the auxiliary bolt 39 are screwed into the bolt hole 36 and the bolt hole 40 in the fixing member 30 in accordance with the wide belt-shaped unit 13. Then, as shown in FIG. 5, the first end portion 13a of the wide belt-shaped unit 13 is entirely covered in the width direction by the main clamp member 31 and the auxiliary clamp member 32, which are continuous on a straight line in the width direction of the belt-shaped unit 13.

In this case, the distance between the main bolt 35, which serves as the first movement restricting portion, and the auxiliary bolt 39, which serves as the second movement restricting portion, in the width direction of the belt-shaped unit 13 is substantially the same as the width of the wide belt-shaped unit 13. Therefore, the first end portion 13a of the wide belt-shaped unit 13 is prevented from being displaced toward the first side or the second side in the width direction by the main bolt 35, which serves as the first movement restricting portion, and the auxiliary bolt 39, which serves as the second movement restricting portion.

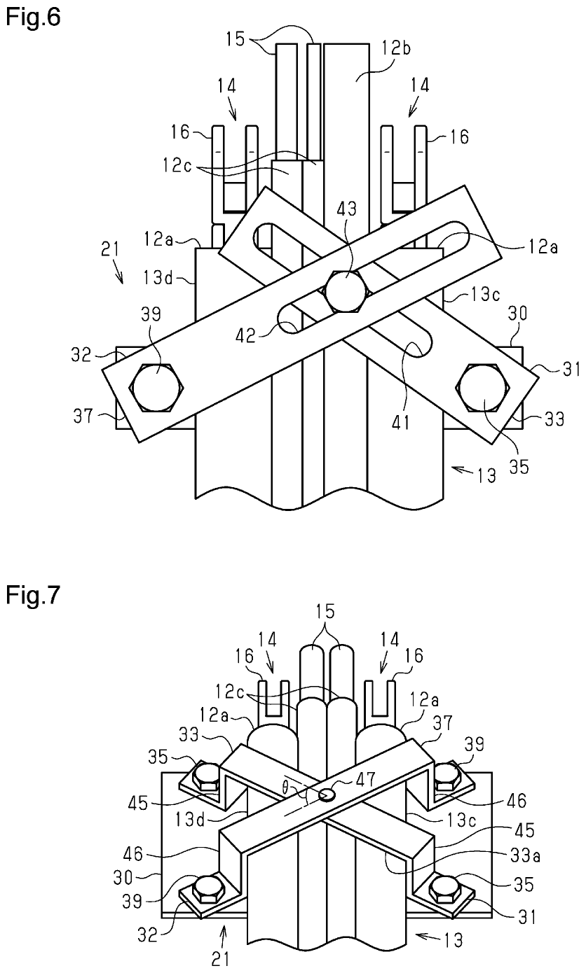

Next, as shown in FIG. 6, among the transmission members 12a, 12b, 12c of the belt-shaped unit 13, when the number of the pressure-transmitting hose-shaped transmission members 12b and the transmission members 12c, through which the cables 15 are inserted, is reduced, so that the belt-shaped unit 13 is narrowed, the following measures are taken. In this case also, the fastening bolt 43 is loosened from the nut 44 in the first clamp device 21. Also, the main bolt 35 is unscrewed from the bolt hole 36, and the auxiliary bolt 39 is unscrewed from the bolt hole 40.

In this case, with the fastening bolt 43 inserted into the first elongated hole 41 and the second elongated hole 42, the main clamp member 31 and the auxiliary clamp member 32 are moved relative to each other. That is, the main clamp member 31 and the auxiliary clamp member 32 are moved relative to each other such that the main bolt 35 and the auxiliary bolt 39 approach each other in the width direction of the belt-shaped unit 13, while the distal end portions of the main clamp member 31 and the auxiliary clamp member 32 intersect with each other in a plan view. Then, when the main bolt 35 comes close to the side edge 13c on the first side in the width direction of the belt-shaped unit 13 and the auxiliary bolt 39 comes close to the side edge 13d on the second side in the width direction of the belt-shaped unit 13, the main clamp member 31 and the auxiliary clamp member 32 no longer move toward each other.

In this state, the fastening bolt 43 is screwed into the nut 44, and the main bolt 35 and the auxiliary bolt 39 are screwed into the bolt hole 36 and the bolt hole 40 in the fixing member 30 in accordance with the narrow belt-shaped unit 13. Then, as shown in FIG. 6, the first end portion 13a of the narrow belt-shaped unit 13 is entirely covered in the width direction by the main clamp member 31 and the auxiliary clamp member 32, the distal end portions of which intersect with each other in a plan view. As described above, the first clamp device 21 is capable of dealing with a case in which the width of the belt-shaped unit 13 becomes relatively wide as shown in FIG. 5 and a case in which the width of the belt-shaped unit 13 becomes relatively narrow as shown in FIG. 6, by moving the main clamp member 31 and the auxiliary clamp member 32 relative to each other in the width direction of the belt-shaped unit 13.

The present embodiment has the following advantages.
(1) When the width of the belt-shaped unit 13 is changed, the main clamp member 31 and the auxiliary clamp member 32 are moved relative to each other to change the degree of overlap therebetween in accordance with the change in the width, so that the belt-shaped unit 13 is entirely covered in the width direction by the main clamp member 31 and the auxiliary clamp member 32. Therefore, the first clamp device 21 and the second clamp device 22, which include the main clamp member 31 and the auxiliary clamp member 32, can be used flexibly even if the width of the belt-shaped unit 13 is changed.
(2) The main bolt 35, which serves as the first movement restricting portion of the main clamp member 31, prevents the first end portion 13a of the belt-shaped unit 13 from being displaced toward the first side in the width direction. Also, the auxiliary bolt 39, which serves as the second movement restricting portion of the auxiliary clamp member 32, prevents the first end portion 13a of the belt-shaped unit 13 from being displaced toward the second side in the width direction.
(3) The main contact portion 33a and the auxiliary contact portion 37a of the main clamp member 31 and the auxiliary clamp member 32 contact the transmission members 12a among the transmission members 12 of the belt-shaped unit 13. This restricts the belt-shaped unit 13 from being displaced upward from the fixing member 30.
(4) The belt-shaped unit 13 prevents the transmission members 12b and 12c at positions other than the opposite ends in the width direction from being crushed by the main contact portion 33a and the auxiliary contact portion 37a. On the other hand, since the transmission members 12a, which are located the opposite ends in the arrangement direction and in which the rigid articulated supporting members 14 are inserted, are pressed by the main contact portion 33a and the auxiliary contact portion 37a. This allows the belt-shaped unit 13 to be fixed in a firm state.

The above-described embodiment may be modified as follows. The features included in the above-described embodiment and the features included in the following modifications can be combined. Also, the features included in the following modifications can be combined.

As in a first modification shown in FIG. 7, the main clamp member 31 and the auxiliary clamp member 32 may be formed by two of band plate-shaped metal members that are bent in the middle in the longitudinal direction. In this case, the main clamp member 31 has a shape in which bent portions 45 are formed by bending at a position close to one end and at a position close to the other end in the longitudinal direction. The bent portions 45 each have a length corresponding to the outer diameter of the transmission members 12a. The auxiliary clamp member 32 has a shape in which bent portions 46 are formed by bending at a position close to one end and at a position close to the other end in the longitudinal direction. The bent portions 46 each have a length corresponding to the outer diameter of the transmission members 12a and the thickness of the main plate portion 33 of the main clamp member 31. The main clamp member 31 and the auxiliary clamp member 32 are rotatably supported by a pivot shaft 47 at their respective central portions in a state in which the longitudinal central portion of the auxiliary clamp member 32 is placed on the longitudinal central portion of the main clamp member 31.

In the first clamp device 21 of the first modification, the main contact portion 33a is a surface that faces the upper surface of the fixing member 30 from above and contacts the transmission members 12a located at the opposite ends of the belt-shaped unit 13 in the arrangement direction. The main plate portion 33 of the main clamp member 31 is configured such that the main contact portion 33a prevents the belt-shaped unit 13 from being displaced upward. That is, in the first clamp device 21 of the first modification, the contact portion for preventing upward displacement of the belt-shaped unit 13 is provided only in the main clamp member 31 of the main clamp member 31 and the auxiliary clamp member 32, and is not provided in the auxiliary clamp member 32.

In this case, for example, when the belt-shaped unit 13 is wider or narrower than the belt-shaped unit 13 shown in FIG. 7, the main clamp member 31 and the auxiliary clamp member 32 are rotated relative to each other after the main bolt 35 and the auxiliary bolt 39 are unscrewed from the bolt hole 36 and the bolt hole 40. That is, when used for a relatively wide belt-shaped unit 13, the main clamp member 31 and the auxiliary clamp member 32 are rotated relative to each other in a direction in which the crossing angle θ decreases. In contrast, when used for a relatively narrow belt-shaped unit 13, the main clamp member 31 and the auxiliary clamp member 32 are rotated relative to each other in a direction in which the crossing angle θ increases. The fixing member 30 has bolt holes 36, 40 formed at positions in correspondence with the wide belt-shaped unit 13 or the narrow belt-shaped unit 13. According to this configuration, the bent portions 45, 46 of the main clamp member 31 and the auxiliary clamp member 32 function as the first movement restricting portion and the second movement restricting portion, and the first clamp device 21 and the second clamp device 22 can be used flexibly when the width of the belt-shaped unit 13 is changed.

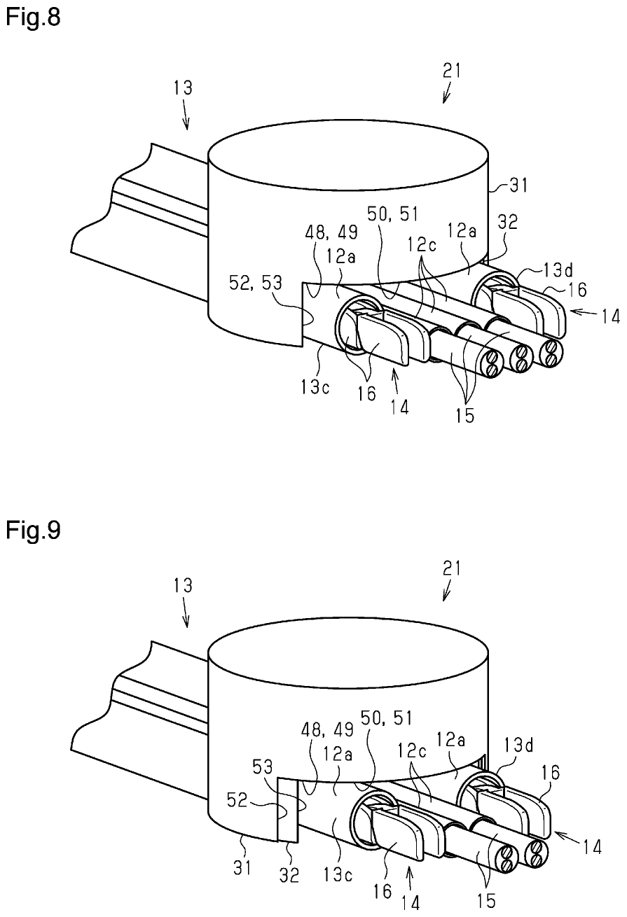

As in a second modification shown in FIGS. 8 and 9, the first clamp device 21 may be configured such that a main clamp member 31 and an auxiliary clamp member 32, each having a cylindrical shape with a closed end, are rotated relative to each other in a state of being fitted to each other. In this case, the main clamp member 31 and the auxiliary clamp member 32 respectively include a cutout portion 48 and a cutout portion 49, which have the same rectangular shape in a side view. The cutout portions 48, 49 extend from an opening edge of a lower end in contact with a surface of a fixing member (not shown) and are formed at positions opposite to each other by 180 degrees in a radial direction. The cutout portions 48, 49, which entirely cover the belt-shaped unit 13 in the width direction, are configured such that arcuate upper edges 50, 51, extending in the circumferential direction of the main clamp member 31 and the auxiliary clamp member 32, abut the transmission members 12a, which are located at the opposite ends in the arrangement direction of the belt-shaped unit 13. That is, in the first clamp device 21 of the second modification, the arcuate upper edges 50, 51 of the cutout portions 48, 49 function as contact portions that prevent upward displacement of the belt-shaped unit 13.

When the belt-shaped unit 13 has the width shown in FIG. 8, the left and right side edge portions 52, 53 of the cutout portions 48, 49 abut the left and right side edges 13c and 13d of the transmission members 12a located at the opposite ends in the arrangement direction of the belt-shaped unit 13. That is, the left and right side edge portions 52, 53 of the cutout portions 48, 49 of the main clamp member 31 and the auxiliary clamp member 32 function as the first movement restricting portion and the second movement restricting portion, which prevent the belt-shaped unit 13 from being displaced in the width direction.

For example, when the width of the belt-shaped unit 13 is narrower than the case shown in FIG. 8, the main clamp member 31 is rotated counterclockwise with respect to the auxiliary clamp member 32, as shown in FIG. 9. In the case of FIG. 9, the side edge portion 53 on the left side of the cutout portion 49 of the auxiliary clamp member 32 contacts the side edge 13c on the first side in the width direction of the belt-shaped unit 13 from the side, and functions as the first movement restricting portion, which prevents the belt-shaped unit 13 from being displaced toward the first side in the width direction. On the other hand, the side edge portion 52 on the right side of the cutout portion 49 of the main clamp member 31 contacts the side edge 13d on the second side in the width direction of the belt-shaped unit 13 from the side, and functions as the second movement restricting portion, which prevents the belt-shaped unit 13 from being displaced toward the second side in the width direction. According to this configuration, the first clamp device 21 and the second clamp device 22 can be used flexibly when the width of the belt-shaped unit 13 is changed.

In the belt-shaped unit 13, the transmission members 12a, into which the articulated supporting members 14 are inserted, may be located at positions other than the opposite ends in the arrangement direction of the transmission members 12a, 12b, and 12c, which is also the width direction of the belt-shaped unit 13.

The number of the transmission members 12, which form the belt-shaped unit 13, and the types, thicknesses, shapes, and the like of the transmission members 12a, 12b, and 12c may be different from those described in the above-described embodiment and the modifications. For example, the transmission members 12, which form the belt-shaped unit 13, may include only the transmission members 12a, into which the articulated supporting members 14 are inserted, and the transmission member 12b, which functions as a pressure-transmitting hose. The transmission members 12 may include only the transmission member 12a and the transmission member 12c, into which the cable 15 is inserted. Furthermore, the transmission members 12 do not necessarily include the transmission members 12a, into which the articulated supporting members 14 are inserted.

Only one of the main contact portion 33a of the main clamp member 31 and the auxiliary contact portion 37a of the auxiliary clamp member 32 may contact with at least one of the transmission members 12 in the belt-shaped unit 13 to prevent the belt-shaped unit 13 from being displaced upward.

In the main clamp member 31 and the auxiliary clamp member 32 of the above-described embodiment, the first movement restricting portion and the second movement restricting portion, which prevent the belt-shaped unit 13 from being displaced in the width direction, may be achieved by providing a separate member having a protruding shape in a position closer to the center in the longitudinal direction than the main bolt 35 and the auxiliary bolt 39.

The flat transmission device 11 in the above-described embodiment may have a configuration in which only one of the first end portion 13a and the second end portion 13b of the belt-shaped unit 13, for example, only the first end portion 13a, is fixed using a clamp device including the main clamp member 31 and the auxiliary clamp member 32.

1. A flat transmission device, comprising:
a belt-shaped unit that includes elongated flexible transmission members arranged in parallel; and
a clamp device configured to fix an end in a longitudinal direction of the belt-shaped unit in a state of entirely covering the end in a width direction of the belt-shaped unit, wherein
the clamp device includes:
a main clamp member that covers at least a part of the end of the belt-shaped unit in the width direction including a side edge of the belt-shaped unit on a first side in the width direction; and
an auxiliary clamp member that covers at least a part of the end of the belt-shaped unit in the width direction including a side edge of the belt-shaped unit on a second side in the width direction, and
the main clamp member and the auxiliary clamp member move relative to each other while partially overlapping with each other in the width direction, thereby cooperatively entirely covering the end of the belt-shaped unit in the width direction.

2. The flat transmission device according to claim 1, wherein
the main clamp member includes a first movement restricting portion located outward of the side edge on the first side of the belt-shaped unit, and
the auxiliary clamp member includes a second movement restricting portion located outward of the side edge on the second side of the belt-shaped unit.

3. The flat transmission device according to claim 1, wherein
at least one of the main clamp member and the auxiliary clamp member includes a contact portion, and
the contact portion contacts at least one of the transmission members so as to limit upward displacement of the belt-shaped unit.

4. The flat transmission device according to claim 3, wherein
the contact portion contacts, among the transmission members, the transmission member located at an edge on the first side in the width direction and the transmission member located at an edge on the second side in the width direction, and
the transmission member located at the edge on the first side and the transmission member located at the edge on the second side are tubular members having larger diameters than the other transmission members located in a middle in the width direction, an elongated bendable articulated supporting member being inserted into each tubular member.

5. A clamp device provided in a flat transmission device, wherein
the flat transmission device includes a belt-shaped unit that includes elongated flexible transmission members arranged in parallel,
the clamp device is configured to fix an end in a longitudinal direction of the belt-shaped unit in a state of entirely covering the end in a width direction of the belt-shaped unit,
the clamp device comprises:
a main clamp member that covers at least a part of the end of the belt-shaped unit in the width direction including a side edge of the belt-shaped unit on a first side in the width direction; and
an auxiliary clamp member that covers at least a part of the end of the belt-shaped unit in the width direction including a side edge of the belt-shaped unit on a second side in the width direction, and
the main clamp member and the auxiliary clamp member move relative to each other while partially overlapping with each other in the width direction, thereby cooperatively entirely covering the end of the belt-shaped unit in the width direction.
